(19) United States
(12) Patent Application Publication
(10) Pub. No.: US 2007/0177766 A1
(43) Pub. Date: Aug. 2, 2007

(54) Biometric authentication apparatus and biometric authentication method

(76) Inventors: Seitaro Kasahara, Tokyo (JP); Takashi Ueda, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/450,718

(22) Filed: Jun. 8, 2006

(30) Foreign Application Priority Data
Feb. 1, 2006 (JP) 2006-024513

(51) Int. Cl. G06K 9/00

(52) U.S. Cl. 382/115

(57) ABSTRACT

Disclosed is a biometric authentication apparatus including: a biometric reading unit reading biometric data; a verification data storage unit storing a plurality of pieces of verification data for verifying against the biometric data; a priority order table storage unit storing a priority order table in which a priority order of searching the plurality of pieces of verification data is set; a control unit registering the priority order into the priority order table, and sequentially searching the verification data at an order based on the priority order registered in the priority order table when the biometric data is read by the biometric reading unit to verify the biometric data against the verification data; and an information unit informing of a verification result by the control unit.

### CROSS-REFERENCE TO RELATED APPLICATION

The present U.S. patent application claims a priority under the Paris Convention of Japanese patent application No. 2006-24513 filed on Feb. 1, 2006, and shall be a basis of correction of an incorrect translation.

### BACKGROUND OF THE INVENTION

1. Field of the Invention

The present invention relates to a biometric authentication apparatus and a biometric authentication method, performing authentication of biometric data.

2. Description of Related Art

In recent years, a biometric authentication using biometric data of a person such as a fingerprint, a vein, an iris, a retina, a hand shape, a facial configuration, a somatotype, a voice print or the like for security protection has been realized. For example, an image formation apparatus such as a copier, a multi-function printer (MFP) or the like, having a person verification function has been studied. Because authentication based on biometric data has no problems of loss unlike authentication by a possession such as an ID card or the like, the biometric data authentication has high convenience and has a feature of the difficulty of masquerade. However, there is a problem in which a time necessary for verification increases and convenience lowers as the number of pieces of biometric data for verification (hereinafter referred to as verification data) increases.

Accordingly, a conventional technique aiming at speeding up verification processing by arranging storage positions of reproduced pieces of fingerprint information for verification (verification data) in the order of accessing frequency has been proposed (for example, refer to JP-2005-149344A). Further, an authentication apparatus aiming at speeding up verification processing by narrowing down registrants having coincidence equal to or higher than a predetermined level stepwise by means of a plurality of pieces of registered biometric information (verification data) has been proposed (for example, refer to JP-2003-186847A).

However, because the techniques disclosed in JP-2005-149344A and JP-2003-186847A perform biometric authentication based on accumulated actual results of access, there is a large possibility that the time necessary for the verification of a low use user becomes longer in comparison with that of a high use user. For example, when it is supposed that the verification data of a new user is stored in an authentication apparatus owing to a personnel change or the like, the priority order of the verification data of the new user is set to be lowest unless the verification data is accessed (authenticated) more frequently than a predetermined number of times. Consequently, there is a large possibility that the time necessary for verification is longer than that of the existing users.

### SUMMARY

The present invention has been made to solve the above problems. An object of the invention is to provide a biometric authentication apparatus and biometric authentication method, capable of improving the time necessary for verification of biometric data.

In order to achieve the above object, according to one embodiment reflecting the first aspect of the invention, the biometric authentication apparatus comprises: a biometric reading unit reading biometric data; a verification data storage unit storing a plurality of pieces of verification data for verifying against the biometric data; a priority order table storage unit storing a priority order table in which a priority order of searching the plurality of pieces of verification data is set; a control unit registering the priority order into the priority order table, and sequentially searching the verification data at an order based on the priority order registered in the priority order table when the biometric data is read by the biometric reading unit to verify the biometric data against the verification data; and an information unit informing of a verification result by the control unit.

According to another embodiment reflecting a second aspect of the invention, the biometric authentication apparatus comprises: a biometric reading unit reading biometric data; a verification data storage unit storing a plurality of pieces of verification data for verifying against the biometric data; a priority order table storage unit storing a priority order table in which a priority order of searching the plurality of pieces of verification data is set; a control unit sequentially searching the verification data in an order based on the priority order when the biometric data is read by the biometric reading unit to verify the biometric data against the read verification data, the control unit changing the priority order of verification data which agrees with the biometric data as a verification result, to a higher rank and changing priority orders of other pieces of verification data to orders according to the change of the priority order of the agreed verification data to update the priority order table; and an information unit informing of the verification result by the control unit.

Preferably, the biometric reading unit reads as the biometric data at least one of a fingerprint, a vein, an iris, a retina, a hand shape, a facial configuration, a somatotype and a voiceprint of the user.

### BRIEF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 is a view showing the internal configuration of an image formation apparatus 1 to which a biometric authentication apparatus of the present invention is applied;

FIG. 2 is a view showing an example of a priority order table stored in a storage unit;

FIG. 3 is a view showing a procedure of biometric authentication processing in the image formation apparatus according to a first embodiment;

FIG. 4 is a view showing a procedure of biometric authentication processing in the image formation apparatus according to a second embodiment;

FIG. 5 is a view showing the procedure of the priority order table update processing;

FIG. 6 is a view for explaining an example of the operation of the priority order table update processing; and

FIG. 7 is a view for explaining another embodiment according to the invention.

### DETAILED DESCRIPTION OF THE PREFERRED EMBODIMENTS

An embodiment relating to the biometric authentication apparatus and method, according to the present invention will be described in detail with reference to the attached drawings.

### First Embodiment

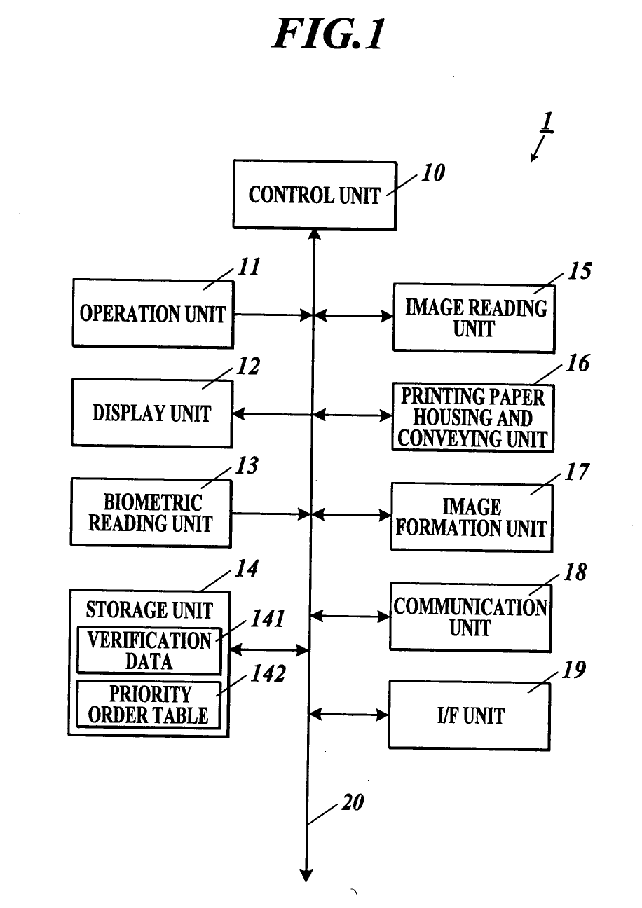

First, the configuration of an image formation apparatus according to the embodiment is described with reference to FIG. 1.

FIG. 1 is a view showing the internal configuration of an image formation apparatus 1 in which a biometric authentication apparatus according to the invention is applied. As shown in FIG. 1, the image formation apparatus 1 is composed of a control unit 10, an operation unit 11, a display unit 12, a biometric reading unit 13, a storage unit 14, an image reading unit 15, a printing paper housing and conveying unit 16, an image formation unit 17, a communication unit 18, an I/F unit 19 and the like. Each unit is connected with each other through a bus 20.

The control unit 10 is composed of a central processing unit (CPU) which is not shown, a random access memory (RAM) and the like. The CPU executes various kinds of processing by using a predetermined region of the RAM as a working area in cooperation with the various control programs previously stored in the storage unit 14, and wholly controls the operation of each unit constituting the image formation apparatus 1.

Specifically, at the time of using the image formation apparatus 1, the control unit 10 executes biometric authentication processing which will be explained later, and performs one-to-N verification of one piece of biometric data read from the biometric reading unit 13 to a plurality (N) of pieces of verification data 141 previously stored in the storage unit 14 in the order based on the priority order registered in a priority order table 142, and the control unit 10 performs control to allow the use of the image formation apparatus 1 only when the biometric data agrees with the verification data 141.

The control unit 10 makes the storage unit 14 store the image data read by the image reading unit 15. Further, the control unit 10 controls the printing paper housing and conveying unit 16 and the image formation unit 17 to make them print the image data read by the image reading unit 15, document data input through the communication unit 18, or the like on a sheet of printing paper.

The operation unit 11 is equipped with input keys and the like, and receives information input by an operation of a user as an input signal to output the input signal to the control unit 10. The image formation apparatus 1 has a configuration so that an administrator or a user thereof can set a priority order of reading or searching the plurality of pieces of verification data 141 stored in the storage unit 14, through the operation unit 11. The priority order table 142 which defines the relationship between the set priority order and the verification data 141 is stored in the storage unit 14.

The display unit 12 is composed of a liquid crystal display (LCD) or the like, and displays various kinds of information based on display signals from the control unit 10. The display unit 10 may be integrally configured with the operation unit 11 to form a touch panel.

The biometric reading unit 13 is an apparatus capable of reading at least one kind of biometric data among various kinds of biometric data indicating physical features of a human being such as a fingerprint, a vein, an iris, a retina, a hand shape, a facial configuration, a somatotype, a voiceprint and the like, and is composed of various function units corresponding to biometric data which is an object to be read. The biometric reading unit 13 reads the biometric data of the user of the image formation apparatus 1 under the control by the control unit 10, and outputs the read biometric data to the control unit 10.

The storage unit 14 is equipped with a nonvolatile storage medium made of a magnetic recording medium, an optical recording medium or a semiconductor memory, and stores programs necessary for the operation of the image formation apparatus 1 and the data relative to the execution of the programs.

Specifically, the storage unit 14 previously stores (or manages) a plurality of pieces of verification data 141 for performing verification to the biometric data read by the biometric reading unit 13 in association with the data IDs. Here, the data IDs mean the identification information capable of uniquely identifying each user (verification data) such as the employee numbers of the users, and the verification data is managed based on the data IDs. Moreover, the storage unit 14 stores the priority order table 142 indicating the relations between the priority orders registered beforehand through the operation unit 11 and the verification data.

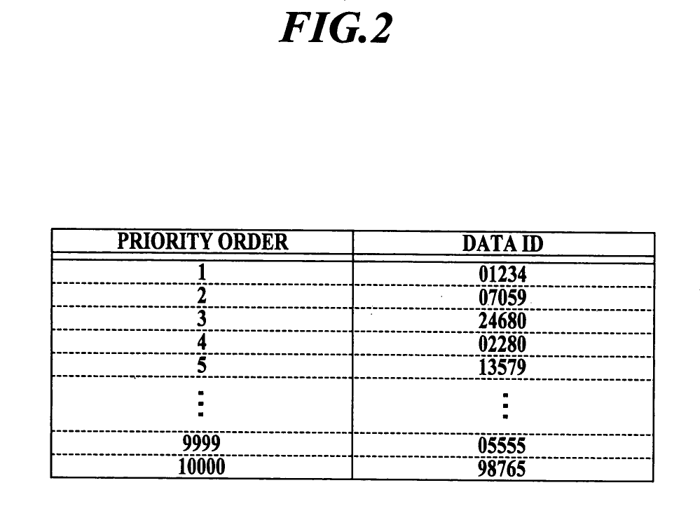

FIG. 2 is a view showing an example of the priority order table 142 stored in the storage unit 14. As shown in FIG. 2, priority orders (1, 2, 3, 4, 5 . . . 9999,10000) and the data IDs of the respective pieces of verification data corresponding to the priority orders are set in association with each other. Incidentally, in the embodiment, it is meant that the first rank has the highest priority order, and the priority orders become gradually lower as the value of the rank increases.

In a time of biometric authentication processing which is described later, the control unit 10 refers to the data IDs in order based on the priority orders of the data ID priority order table 142 to read the verification data 141 corresponding to each data ID in order, and performs verification to the biometric data of the user read by the biometric reading unit 13.

In FIG. 1, the image reading unit 15 includes a light source radiating light onto a manuscript, an image sensor such as a charge coupled device (CCD) image sensor, a complementary metal-oxide semiconductor (CMOS) image sensor or the like, which photoelectrically converts the light reflected from the manuscript, a scanning unit scanning the light to be radiated to the manuscript, an image processing unit performing various kinds of conversions and processing of an electric signal read by the image sensor to output image data, and the like, which are not shown. Under control by the control unit 10, the image reading unit 15 reads an image recorded in the manuscript, and generates image data to output the generated image data to the control unit 10.

The printing paper housing and conveying unit 16 includes a printing paper housing unit housing printing paper therein, a printing paper existence detection unit detecting whether printing paper is housed in the printing paper housing unit or not, a size detection unit detecting the paper size of the printing paper housed in the printing paper housing unit, a conveyance unit conveying the printing paper housed in the printing paper housing unit, and the like, all not shown. Under the control of the control unit 10, the printing paper housing and conveying unit 16 conveys the printing paper of the paper size according to image data or instructed through the operation unit 11 to the image formation position of the image formation unit 17, and ejects the printing paper after image formation.

The image formation unit 17 is a printer of an ink jet type, a laser type, a thermal transfer type, a dot impact type or the like, and forms and records an image on printing paper based on the image data input from the control unit 10.

The communication unit 18 is a modulator/demodulator (modem), a terminal adapter, a LAN adapter and the like, and performs the communication control of various kinds of information given and received between the other equipment connected to the network such as WAN (Wide Area Network), LAN (Local Area Network) and like, under control by the control unit 10.

The I/F unit 19 is a communication interface which performs data communications with other apparatus, and is configured by, for example, universal serial bus (USB), IEEE 1284, IEEE 1394, PCMCIA or the like. Incidentally, the embodiment adopts a mode to store the verification data 141 and the priority order table 142 into the storage unit 14. But, when an external storage unit is connected to the I/F unit 19, a mode to store the verification data 141 and/or the priority order table 142 may be adopted.

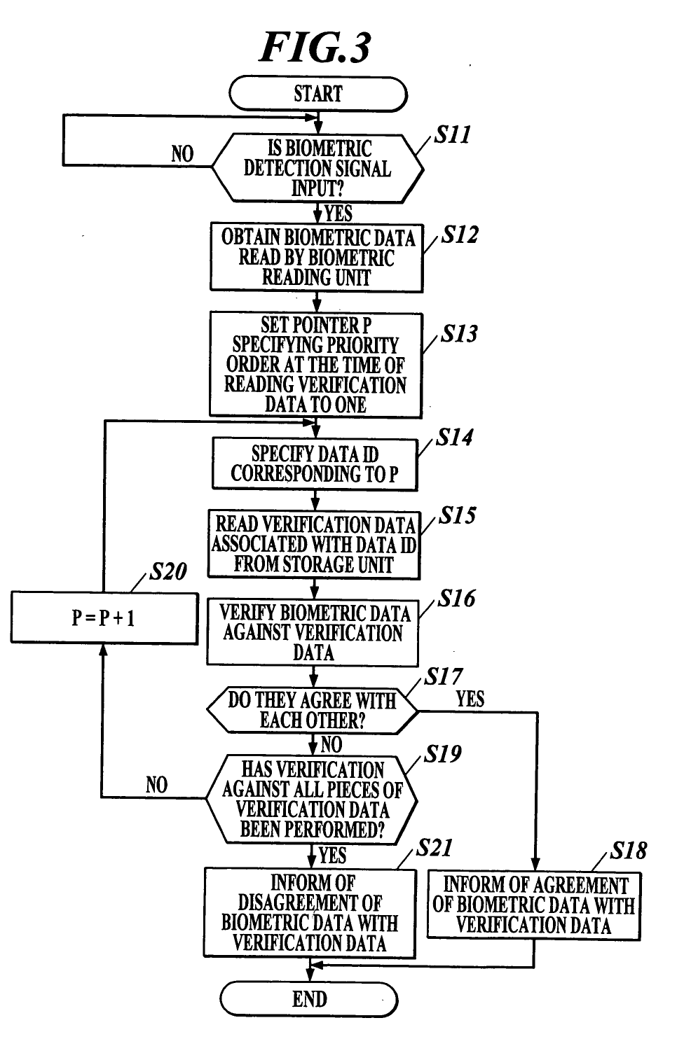

In the following, with reference to FIG. 3, the operation of the image formation apparatus 1 according to the embodiment is described.

FIG. 3 is a view showing the procedure of the biometric authentication processing of the image formation apparatus 1 according to the embodiment. In FIG. 3, each processing is performed in cooperation with the control unit 10 and a predetermined program stored in the storage unit 14.

First, when the biometric authentication processing is started based on a biometric detection signal input from the biometric reading unit 13 (Step S11; Yes), the biometric data read by the biometric reading unit 13 is obtained (i.e., input) (Step S12).

Next, the pointer P specifying the priority order when verification data is read based on a data ID of the priority order table 142 is set to the first rank (P=1) (Step S13).

Successively, the data ID corresponding to the pointer P is specified based on the priority order table 142 (Step S14), and the verification data 141 stored in association with the data ID is read from the storage unit 14 (Step S15). When the read verification data 141 is verified against the biometric data obtained at Step S12 (Step S16), and it is judged whether both the data agree with each other or not (Step S17).

When it is judged that the verification data 141 and the biometric data agree with each other at Step S17 (Step S17; Yes), the information indicating agreement of the biometric data and the verification data 141 (for example, the character information such as “We succeeded in authentication.” or the like) is displayed on the display unit 12 to inform the user of the agreement (Step S18). Thereafter, the information ascertaining whether the agreed verification data is deleted or not (for example, the character information “Is the verification data deleted?” or the like) is displayed on the display unit 12 (Step S19), and the processing is ended.

On the other hand, when it is judged that the verification data 141 and the biometric data do not agree with each other at Step S17 (Step S17; No), it is judged whether all pieces of verification data 141 stored in the storage unit 14 have been verified against the biometric data or not (Step S19). Here, when it is judged that there is non-verified verification data 141 (Step S19; No), the increment of the pointer P by one (P=P+1) is performed, and thereby the priority order is lowered by one rank (Step S20). Thereafter the procedure returns to Step S14 again.

On the other hand, when it is judged that all pieces of verification data 141 have been verified against the biometric data at Step S19 (Step S19; Yes), the information indicating disagreement of the biometric data with the verification data 141 (for example, the character information such as “The verification data has not been registered yet.” or the like) is displayed on the display unit 12, to inform the user of it (Step S21). Then, the processing is ended.

As described above, in the image formation apparatus 1 of the embodiment, the priority order by which the verification data is read can be registered in the priority order table 142, and the verification data 141 is read by the order based on the priority order registered in the priority order table to perform the verification to the biometric data. Thereby, it becomes possible to set the priority order according to the using situations of users in advance. Consequently, the time necessary for the verification with the biometric data can be improved.

### Second Embodiment

Next, a second embodiment of the present invention is described. Incidentally, for the simplification of the description, the same components as those of the first embodiment are denoted by the same reference marks as those of the first embodiment, and the detailed descriptions of them are suitably omitted.

First, with reference to FIG. 1, the internal configuration of the image formation apparatus 1 of the present embodiment is described.

At the time of the use of the image formation apparatus 1, the control unit 10 of the embodiment performs the following control. That is, the control unit 10 executes the biometric authentication processing which will be described later, and sequentially verifies the biometric data read by the biometric reading unit 13 against the plurality of pieces of verification data 141 stored in the storage unit 14 in the order based on the priority order registered in the priority order table 142 in advance to authenticate the user of the image formation apparatus 1. Then, the control unit 10 allows the user to use the present image formation apparatus 1 only when the biometric data and the verification data 141 agree with each other.

Here, the control unit 10 updates the priority order table 142 by changing the priority order of the verification data 141 agreeing with the biometric data, and by changing the priority orders of the pieces of the other verification data 141 to the orders according to the change of the priority order of the agreed verification data 141.

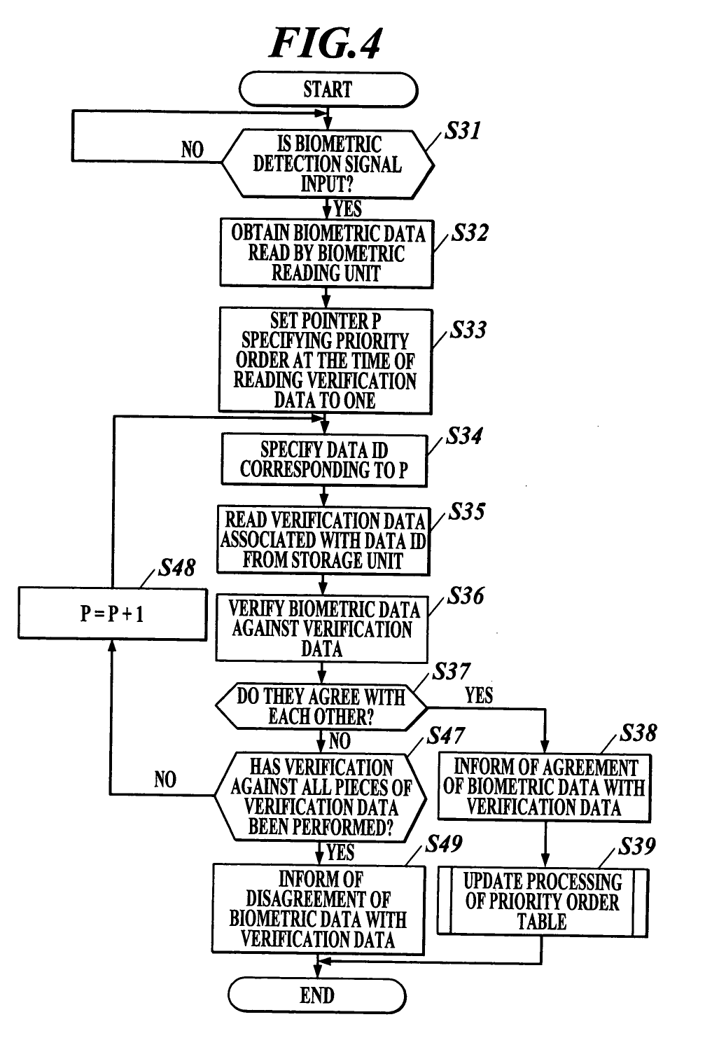

In the following, with reference to FIGS. 4-6, the operation of the image formation apparatus 1 of the present embodiment is described.

FIG. 4 is a view showing the procedure of the biometric authentication processing of the image formation apparatus 1 of the embodiment. In addition, each processing of FIG. 4 shows the processing executed by the cooperation with a predetermined program stored in the storage unit 14 under control of the control part 10.

First, the present biometric authentication processing is started based on a biometric detection signal input from the biometric reading unit 13 (Step S31; Yes). The biometric data read by the biometric reading unit 13 is obtained (input) (Step S32).

Next, the pointer P specifying the priority order when verification data is read based on a data ID of the priority order table 142 is set to the first rank (P=1) (Step S33).

Successively, the data ID corresponding to the present pointer P is specified based on the priority order table 142 (Step S34), and the verification data 141 stored in association with the data ID is read from the storage unit 14 (Step S35). The read verification data 141 is verified with the biometric data obtained at Step S32 (Step S36), and it is judged whether both the data agree with each other or not (Step S37).

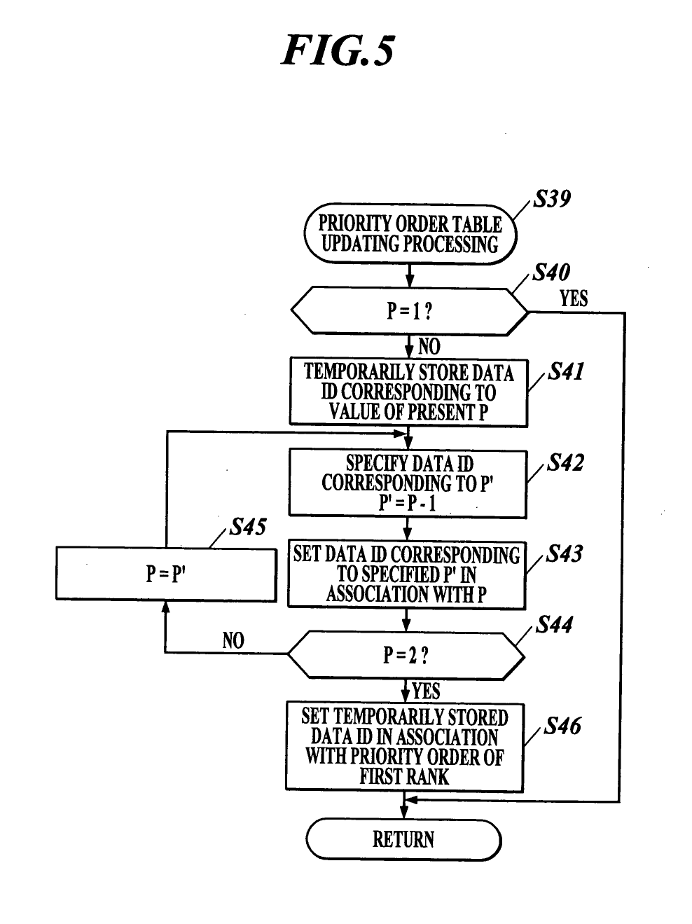

When it is judged that the verification data 141 and the biometric data agree with each other here (Step S37; Yes), the information indicating the agreement of the biometric data and the verification data 141 (for example, the character information such as “We succeeded in authentication.” or the like) is displayed on the display unit 12 to inform the user of the agreement (Step S38). Thereafter, the processing moves to the priority order table update processing at Step S39. In the following, with reference to FIG. 5, the priority order table update processing at Step S39 is described.

FIG. 5 is a view showing the procedure of the priority order table update processing.

First, it is judged whether “1” indicating the first rank is set at the present pointer P or not (Step S40). Here, when it is judged that “1” is set at the pointer P (Step S40; Yes), the present processing and the biometric authentication processing are immediately ended.

On the other hand, when it is judged that “2” or more value is set at the point P (Step S40; No), the data ID of the priority order corresponding to the present pointer P is temporarily stored in a not shown RAM or a predetermined region of the storage unit 14 (Step S41). Thereafter, a data ID corresponding to P′ (P′=P−1) produced by the decrement of 1 from the value of the present pointer P is specified (Step S42), and the specified data ID is set in association with the priority order corresponding to the present pointer P. Thereby, the priority order thereof is carried down by one rank (Step S43).

Next, it is judged whether “2” is set at the present pointer P or not. When it is judged that the value of “3” or more is set (Step S44; No), the present point P is set to P′ (P=P′). Thereby, the priority order is set at a higher rank by one (Step S45), and then the processing returns to Step S42 again.

On the other hand, when it is judged that “2” is set at the present pointer P at Step S44 (Step S44; Yes), the data ID stored temporarily at Step S41 is set in association with the first rank, the highest priority order, (Step S46), and the present processing and the biometric authentication processing are immediately ended.

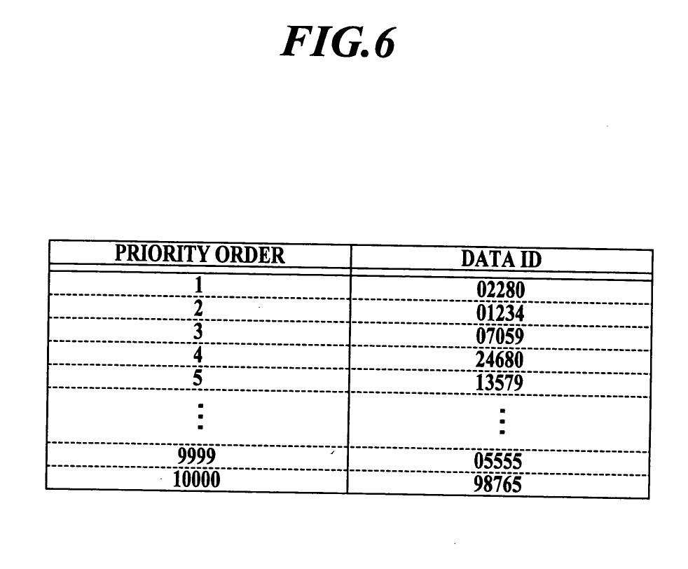

In the following, the operation of the priority order table update processing is described with reference to FIGS. 2 and 6.

When the control unit 10 judges that the biometric data of the user of the image formation apparatus 1 agrees with the verification data 141 of the data ID at the fourth rank of the priority order by the verification in the image formation apparatus 1, which stores the priority order table 142 shown in FIG. 2 in the storage unit 14, the control unit 10 executes the priority order table update processing described above (Step S39) to carry up the data ID at the fourth rank originally to the first rank, and carries down the data IDs at from the first rank to the third rank originally to from the second rank to the fourth rank, respectively.

In this manner, when the verification of the biometric data and the verification data 141 indicates the agreement of them, the priority order of the data ID corresponding to the agreed verification data 141 is changed to the highest rank (first rank), and thereby the verification data 141 is set to be read preferentially. Furthermore, the priority orders of the data IDs corresponding to the other pieces of the verification data 141 are changed to the orders according to the change of the priority order of the data ID corresponding to the agreed verification data 141. In addition, the mode in which the priority order of the data ID corresponding to the verification data 141 agreeing with the biometric data is carried up at the highest rank is adopted by the present embodiment. But, as long as a mode is one performing the change to the priority order at a higher rank from the original priority order, the priority order after the change does not especially matter.

Returning to FIG. 4, when it is judged that the verification data 141 and the biometric data do not agree with each other at Step S37 (Step S37; No), it is judged whether all pieces of verification data 141 stored in the storage unit 14 have been verified with the biometric data or not (Step S47). Here, when it is judged that there is un-verified verification data 141 (Step S47; No), the increment of the pointer P by one (P =P+1) is performed, and thereby the priority order is lowered by one rank (Step S48). After that, the processing returns to Step S34 again.

On the other hand, when it is judged that all pieces of verification data 141 have been verified with the biometric data at Step S47 (Step S47; Yes), the information indicating the disagreement of the biometric data with the verification data 141 (for example, the character information such as “The verification data has not been registered yet.” or the like) is displayed on the display unit 12, and the disagreement is informed to the user (Step S47). After that, the present processing is ended.

As described above, according to the image formation apparatus 1 of the present embodiment, the verification data 141 is read at an order based on the priority order set in the priority order table 142, and the read verification data 141 is verified with the biometric data. When the verification result indicates the agreement of them, the priority order of the agreed verification data 141 is changed to a higher rank, and the priority orders of the other pieces of the verification data 141 are changed to the orders according to the change of the priority order of the agreed verification data 141. Thus the priority order table 142 is updated. Thereby, because it becomes possible to read the verification data 141 preferentially from the next authentication time, the time necessary for the verification of the biometric data can be improved.

The detailed configurations and the detailed operation of the image formation apparatus 1 in the embodiments described above can be suitably modified within the scope without departing from the sprit of the invention.

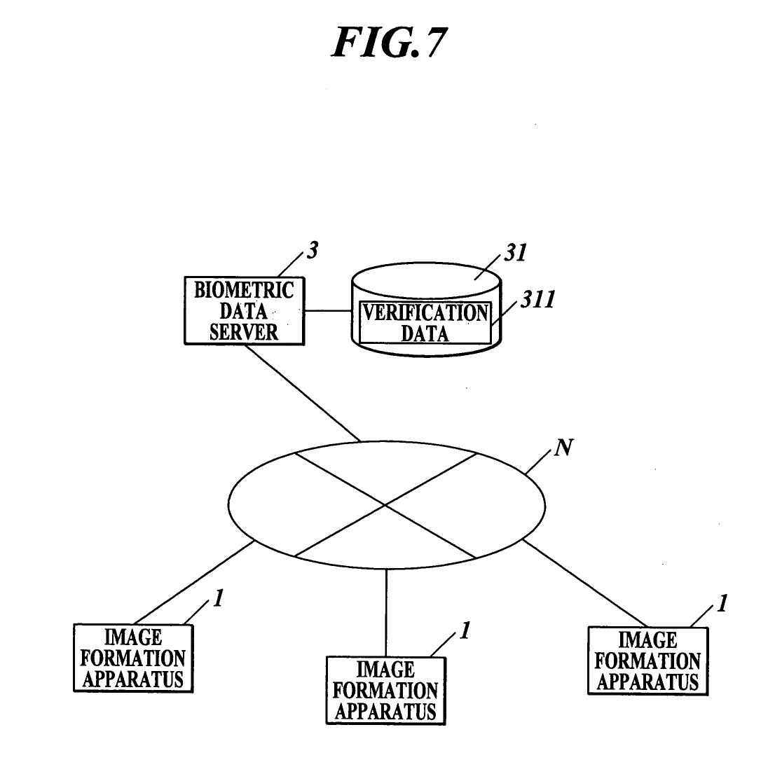

For example, although the mode in which the verification data 141 is previously stored in the storage unit 14 in the above embodiment, the present invention is not limited to such a mode. As shown in FIG. 7, a mode in which the verification data 141 is stored in a biometric data server 3 provided with a storage unit 31 including a data management region such as a database may be adopted. Here, it is supposed that the image formation apparatus 1 and the biometric data server 3 are mutually connected in the state capable of communicating with each other through a network N such as a wide area network (WAN), a local area network (LAN) or the like.

In this mode, the control unit 10 is configured to periodically or occasionally obtain (download) verification data 311 stored in the storage unit 31 of the biometric data server 3, and to store the verification data 311 into the storage unit 14 as verification data 141. By adopting the mode in which the plurality of image formation apparatus 1 shares the verification data 311 stored in one biometric data server 3 in this manner, the verification data 141 can be unified. Consequently, it becomes unnecessary for each image formation apparatus 1 to perform the management of the verification data 141 severally, and it becomes possible to manage the system efficiently.

Moreover, although the embodiments described above adopt a mode in which the execution of the procedure of each processing is realized by the cooperation of the control unit 10 and the predetermined programs stored in the storage unit 14, the execution mode is not limited to the one, but the mode may be realized by exclusive hardware circuits.

What is claimed is:

1. A biometric authentication apparatus comprising:
a biometric reading unit reading biometric data;
a verification data storage unit storing a plurality of pieces of verification data for verifying against the biometric data;
a priority order table storage unit storing a priority order table in which a priority order of searching the plurality of pieces of verification data is set;
a control unit registering the priority order into the priority order table, and sequentially searching the verification data at an order based on the priority order registered in the priority order table when the biometric data is read by the biometric reading unit to verify the biometric data against the verification data; and
an information unit informing of a verification result by the control unit.

2. The biometric authentication apparatus of claim 1, wherein the biometric reading unit reads as the biometric data at least one of a fingerprint, a vein, an iris, a retina, a hand shape, a facial configuration, a somatotype and a voiceprint of the user.

3. A biometric authentication apparatus comprising:
a biometric reading unit reading biometric data;
a verification data storage unit storing a plurality of pieces of verification data for verifying against the biometric data;
a priority order table storage unit storing a priority order table in which a priority order of searching the plurality of pieces of verification data is set;
a control unit sequentially searching the verification data in an order based on the priority order when the biometric data is read by the biometric reading unit to verify the biometric data against the read verification data, the control unit changing the priority order of verification data which agrees with the biometric data as a verification result, to a higher rank and changing priority orders of other pieces of verification data to orders according to the change of the priority order of the agreed verification data to update the priority order table; and
an information unit informing of the verification result by the control unit.

4. The biometric authentication apparatus of claim 3, wherein the biometric reading unit reads as the biometric data at least one of a fingerprint, a vein, an iris, a retina, a hand shape, a facial configuration, a somatotype and a voiceprint of the user.

5. A biometric authentication method comprising:
a biometric reading step reading biometric data;
a verification data storage step storing a plurality of pieces of verification data for verifying against the biometric data;
a priority order table storage step storing a priority order table in which a priority order of searching the plurality of pieces of verification data is set;
a control step registering the priority order into the priority order table, and sequentially searching the verification data at an order based on the priority order registered in the priority order table when the biometric data is read at the biometric reading step to verify the biometric data against the verification data; and
an information step informing of a verification result by the control unit.

6. The biometric authentication method of claim 5, wherein the biometric reading step reads as the biometric data at least one of a fingerprint, a vein, an iris, a retina, a hand shape, a facial configuration, a somatotype and a voiceprint of the user.

7. A biometric authentication method comprising:
a biometric reading step reading biometric data;
a verification data storage step storing a plurality of pieces of verification data for verifying against the biometric data;
a priority order table storage step storing a priority order table in which a priority order of searching the plurality of pieces of verification data is set;
a control step sequentially searching the verification data in an order based on the priority order when the biometric data is read at the biometric reading step to verify the biometric data against the read verification data, the control step changing the priority order of verification data which agrees with the biometric data as a verification result, to a higher rank and changing priority orders of other pieces of verification data to orders according to the change of the priority order of the agreed verification data to update the priority order table; and
an information step informing of the verification result at the control step.

8. The biometric authentication method of claim 7, wherein the biometric reading step reads as the biometric data at least one of a fingerprint, a vein, an iris, a retina, a hand shape, a facial configuration, a somatotype and a voiceprint of the user.
